(19) United States
(12) Patent Application Publication
(10) Pub. No.: US 2007/0183883 A1
(43) Pub. Date: Aug. 9, 2007

(54) Construction Vehicle Attachment for Transporting and Pouring Flowable Materials

(76) Inventor: John Bacon, Springfield, IL (US)

Correspondence Address: LAW OFFICES OF MARK E WIEMELT, PC, 10 SOUTH LASALLE STREET, STE. 3300, CHICAGO, IL, 60603, US

(21) Appl. No.: 11/307,431

(22) Filed: Feb. 7, 2006

(51) Int. Cl. B66C 23/00

(52) U.S. Cl. 414/724

(57) ABSTRACT

Disclosed is an attachment to a construction vehicle which facilitates the transport and pouring of flowable materials such as concrete. The device contains a carrier bucket shaped substantially like an inverted cone, truncated on one side, with a pouring spout along a top edge. The device is quickly and conveniently attached to a front end loader or other suitable construction vehicle which is able to navigate to various pour sites where the material is to be distributed. The carrier bucket is tipped forward by the hydraulics of the construction vehicle and the concrete pours over the spout of the top edge, thereby providing a workable, manageable flow which can be accurately directed to specific areas as needed.

### BACKGROUND OF THE INVENTION

1. Field of the Invention

The present invention relates to an apparatus useful in combination with construction vehicles, and, more particularly, to attachments to construction vehicles which facilitate the transport and pouring of flowable materials such as concrete.

2. The Prior Art

When pouring concrete and other heavy, flowable materials, it is desirable to accurately direct the flow to a particular location. In the case of concrete, this is often accomplished by using concrete mixing trucks equipped with troughs, a solution that works well when the pour site is located near a street or a paved thoroughfare. However, for various reasons, it can be difficult to position a concrete truck directly at the site where the concrete is needed. In many situations, the path to the site is blocked by obstacles such as fences, landscaping features, unsuitable terrain or other elements incompatible with traversal by a large construction vehicle. Smaller construction vehicles, such as front end loaders, are more versatile in their ability to navigate to various pour sites, but most do not have the ability to transport large amounts of concrete. Even when they are able to do so, they typically do not have the ability to pour or otherwise distribute the concrete in a controlled, workable manner. A front end loader, for example, is capable of carrying relatively large quantities of concrete, but the wide mouth of the conventional loader attachment makes spillage likely during transport, and, when the pour site is reached, the load is delivered indiscriminately and inaccurately. As a result, the final leg of the concrete's journey is often made by wheelbarrow, which is not only costly in terms of labor expended, but also costly due to the fact that concrete can set prematurely if too much time is taken delivering the concrete to its ultimate destination.

There is a need in the art for a device which attaches quickly and conveniently to a construction vehicle and facilitates the transport and controlled pouring of large amounts of a heavy, flowable material such as concrete.

### SUMMARY OF THE INVENTION

The present invention is a device which removably attaches to a construction vehicle and facilitates the transport and pouring of large amounts of flowable materials such as concrete. The device has a carrier bucket shaped substantially like an inverted cone, truncated on one side, with a pouring spout along a top edge. The carrier bucket contains a means to attach the device to a construction vehicle.

The device is quickly and conveniently attached to a front end loader or other suitable construction vehicle. The front end loader drives to a concrete mixer and the carrier bucket is filled with concrete. The vehicle then navigates to the pour site where the material is needed. The carrier bucket is tipped forward by the hydraulics of the construction vehicle and the concrete pours over the spout of the top edge, thereby providing a workable, manageable flow which can be accurately directed to specific areas as needed.

Before explaining the preferred embodiment and an alternative embodiment of the present invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of description and should not be regarded as limiting.

It is an object of this invention to provide a device which removably attaches to a construction vehicle and facilitates the transport and pouring of flowable materials such as concrete.

It is an object of this invention to provide a device which reduces spillage and waste of concrete during transport.

It is a further object of this invention to provide a means for transporting and pouring concrete which utilizes the hydraulic power of the loader to accomplish the tasks.

It is a further object of this invention to provide a safe and inexpensive attachment which increases the efficiency of construction vehicles.

It is an advantage of this invention to provide a device which quickly and conveniently attaches to a construction vehicle to enhance its effectiveness and overall performance.

These and other objects of the present invention will become apparent in view of the present specification, claims and drawings.

There has thus been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the present invention in any way.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention and an alternative embodiment.

### BRIEF DESCRIPTION OF THE DRAWINGS

FIG. 1 is a perspective view of the preferred embodiment of the invention showing the top and side of the construction vehicle attachment for the transport and pouring of flowable material.

FIG. 2 is a side elevational view of the construction vehicle attachment of the preferred embodiment of the invention.

FIG. 3 is a front elevational view of the preferred embodiment of the invention.

FIG. 4 is a top elevational view of the preferred embodiment of the invention.

FIG. 5 is a side elevational view of the preferred embodiment of the invention connected to a front end loader.

### DETAILED DESCRIPTION OF THE PREFERRED EMBODIMENT

While the invention may be susceptible to embodiments in different forms, there will be described in detail the preferred embodiment and an alternative embodiment with the understanding that the present disclosure is to be considered an exemplification of the principles of the invention, and is not intended to limit the claims to that which is described herein.

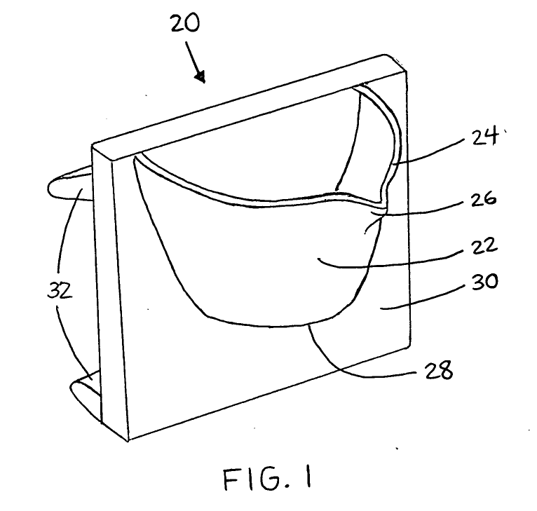

Referring now to FIG. 1, the concrete working attachment 20 of the preferred embodiment of the invention is shown in a side perspective view illustrating the top, side and front of the device. The bucket carrier 22 forms the main body of the attachment 20 and is shaped substantially like an inverted cone with a wide, substantially semicircular top tapering to a narrow circular base 28. The top edge 24 contains a spout 26 from which the flowable material is poured. The spout 26 enables concrete and other heavy, flowable materials to be directed to specific locations with a high degree of control and accuracy. The side of the attachment 20 opposite the spout 26 is truncated and contains an attachment means 30 whereby the attachment 20 can be connected to a construction vehicle. In the preferred embodiment, the attachment means 30 is a Bobcats® Bob-Tach mounting system, an industry standard which enables particularly quick and convenient attachment to and removal from a skid-steer loader. The Bob-Tach mounting system and others like it make use of a pair of mounting brackets 32 positioned along the length of the attachment 20. A corresponding component on the construction vehicle (not shown) fits between the mounting brackets 32 and thereby locks the attachment 20 onto the construction vehicle. In alternate embodiments, the attachment means may contain an alternate arrangement to receive a different type of component from a construction vehicle.

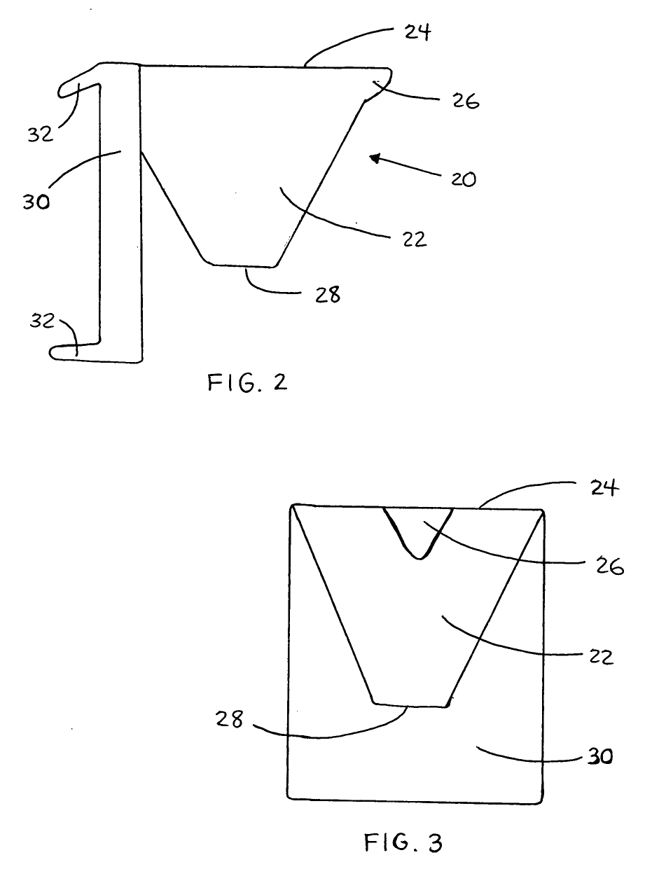

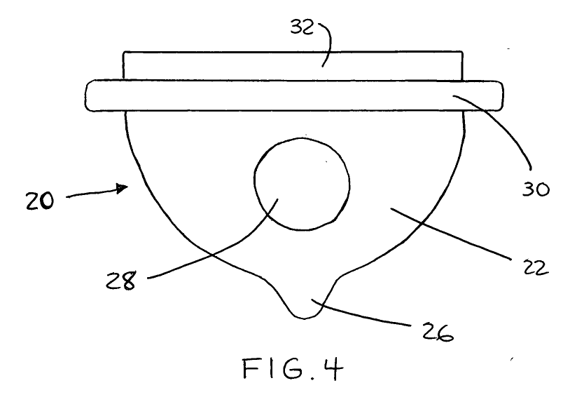

Referring now to FIGS. 2 and 3, the inverted cone shape of the carrier bucket 22 of the preferred embodiment of the invention is shown. While transporting concrete or other materials to the pour site, the carrier bucket 22 is maintained in the upright position to minimize spillage of its contents. When the pour site is reached, the concrete is poured by tipping the carrier bucket 22 forward using the hydraulics of the construction vehicle. The particular shape of the carrier bucket 22 allows relatively large amounts of concrete to be carried while maintaining the ability to transport the concrete with little or no spillage and to pour the concrete in a controlled, workable manner.

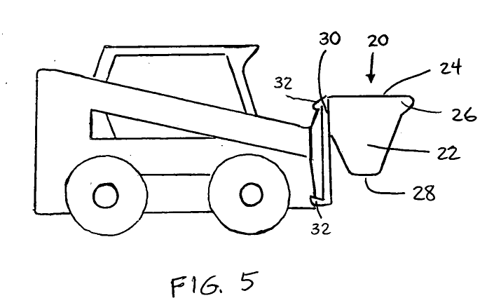

FIG. 4 shows a top view of the attachment 22 of the preferred embodiment of the invention.

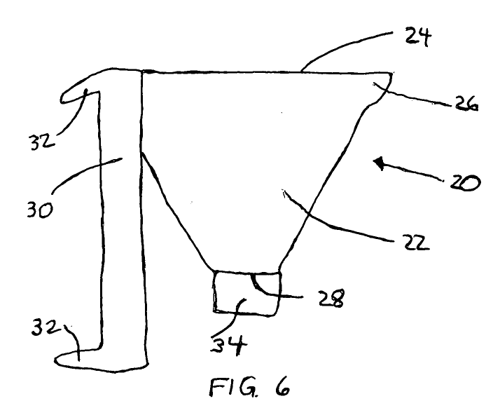

FIG. 5 shows the attachment 22 of the preferred embodiment of the invention in use while attached to a Bobcat® construction vehicle. The invention is particularly well suited to use with this type of construction vehicle.

FIG. 6 shows an alternate embodiment of the invention having a valve 34 disposed in cooperative engagement with the circular base 28 for selectively opening, partially or wholly, and closing of the valve 34 to allow for the flow of flowable materials therethrough. It should be readily understood by those skilled in the art that a variety of valves may be well-suited for use in connection with the alternate embodiment of the present invention. It should also be readily understood by those skilled in the art that the valve 34 may be operatively connected to the hydraulics of the construction vehicle 28 for selectively opening, partially or wholly, and closing of the valve 34.

Hence, while the invention has been described in connection with a preferred embodiment and an alternative embodiment, it will be understood that it is not intended that the invention be limited to those embodiments. On the contrary, it is intended to cover all alternatives, modifications and equivalents as may be included within the spirit and scope of the invention as disclosed.

As to the manner of usage and operation of the instant invention, same should be apparent from the above disclosure, and accordingly no further discussion relevant to the manner of usage and operation of the instant invention shall be provided.

With respect to the above description then, it is to be realized that the optimum proportions for the elements of the invention, and variations in size, materials, shape, form, function and manner of operation, assembly and use, are deemed readily apparent and obvious to one skilled in the art, and all equivalent relationships described in the specification are intended to be encompassed by the present invention.

Therefore, the foregoing is considered illustrative of only the principles of the invention. Further, since numerous modifications and changes will readily occur to those skilled in the art, it is not desired to limit the invention to the exact method, construction and operation shown and described, and accordingly, all suitable modifications and equivalents may be resorted to, falling within the scope of the invention.

What is claimed is:

1. An apparatus removably attachable to a construction vehicle to facilitate the transport and pouring of flowable material comprising: a carrier bucket and a means for attachment to a construction vehicle;
the carrier bucket shaped substantially like an inverted cone, said cone being truncated on one side.

2. The apparatus of claim 1 further comprising a top edge having a spout integrally formed therein.

3. An apparatus removably attachable to a construction vehicle to facilitate the transport and pouring of flowable material comprising: a carrier bucket and a means for attachment to a construction vehicle; the carrier bucket shaped substantially like an inverted cone, said cone being truncated on one side; said carrier bucket tapering to a base; and a valve disposed in cooperative engagement with the base for selectively opening, partially or wholly, and closing of said valve to allow for the flow of flowable materials therethrough.

4. The apparatus of claim 3 further comprising a top edge having a spout integrally formed therein.
